(19) United States
(12) Patent Application Publication
(10) Pub. No.: US 2022/0164240 A1
(43) Pub. Date: May 26, 2022

(54) METHOD AND SYSTEM FOR PROVIDING ONE-CLICK DISTRIBUTION SERVICE IN LINKAGE WITH CODE REPOSITORY

(71) Applicant: COMMON COMPUTER INC., Seoul (KR)

(72) Inventors: Minhyun KIM, Seoul (KR); Dongil SEO, Seoul (KR); Seonghwa YUN, Seongnam-si (KR); Minsu LEE, Seoul (KR); Daesung KIM, Yongin-si (KR); Laeyoung CHANG, Seoul (KR); Minho RYANG, Seongnam-si (KR); Seungho KIM, Yongin-si (KR); Hanjeong LEE, Seoul (KR)

(21) Appl. No.: 17/406,843

(22) Filed: Aug. 19, 2021

(30) Foreign Application Priority Data
Nov. 25, 2020 (KR) 10-2020-0160253

(51) Int. Cl. G06F 9/50; G06F 8/70; G06F 8/36

(52) U.S. Cl. CPC G06F 9/5066; G06F 8/36; G06F 8/70; G06F 9/5055

(57) ABSTRACT

Provided is a method for providing a one-click distribution service in linkage with a code repository, including transmitting, by a service platform, information on a source code included in a code repository selected by a user client to a manager node, allocating, by the manager node, a task associated with the source code to one or more worker nodes, and receiving information on a task result of the task from the one or more worker nodes, receiving, by the service platform, the information on the task result from the manager node, and transmitting, by the service platform, the information on the task result to the user client so that the user client outputs a user interface to execute the task result.

### CROSS-REFERENCE TO RELATED APPLICATION

This application claims priority under 35 U.S.C § 119 to Korean Patent Application No. 10-2020-0160253, filed in the Korean Intellectual Property Office on Nov. 25, 2020, the entire contents of which are hereby incorporated by reference.

### BACKGROUND OF THE INVENTION

### Field of Invention

The present disclosure relates to a method and a system for providing a one-click distribution service in linkage with a code repository, and more specifically, to providing a method and a system for assigning execution and/or distribution tasks of source code included in a code repository to one or more worker nodes to perform the tasks.

### Description of Related Art

In general, many open source projects are shared through services (e.g., GitHub) that provide source code hosting and sharing functions. In addition, through these services, developers can focus on development tasks that can create new value based on existing source codes without the need to develop new source codes from scratch.

However, more than tens of millions of new open source repositories are created every year, and the runtime environments such as operating systems, programming languages, libraries, frameworks, and the like required to execute the source code of each open source project are becoming more diverse. In particular, in the case of projects related to artificial intelligence or machine learning, it is also necessary to consider the hardware execution environment according to various combinations of CPU, GPU, memory, main board, cooling device, power supply, and the like for compatibility with the source code runtime environment.

For these reasons, a source code developer or a source code user need to spend more time and effort in building the execution environment that can execute the source code, than the time and effort spent on the development of the source code itself. In addition, it requires a considerable amount of cost for the source code developer or source code user to directly prepare the execution environment and execute the machine learning task.

### SUMMARY

In order to solve the problems described above, the present disclosure provides a method for, a computer program stored in a non-transitory recording medium for, and a device (system) for providing a one-click distribution service in linkage with a code repository.

The present disclosure may be implemented in various ways, including a method, a system, a non-transitory computer-readable storage medium storing instructions, or a computer program.

According to an embodiment, a method for providing a one-click distribution service in linkage with a code repository may include transmitting, by a service platform, information on a source code included in a code repository selected by a user client to a manager node, allocating, by the manager node, a task associated with the source code to one or more worker nodes, and receiving information on a task result of the task from the one or more worker nodes, receiving, by the service platform, the information on the task result from the manager node, and transmitting, by the service platform, the information on the task result to the user client so that the user client outputs a user interface to execute the task result.

According to an embodiment, the transmitting, by the service platform, the information on the source code included in the code repository selected by the user client to the manager may include analyzing, by the service platform, the source code included in the code repository selected by the user client, to calculate computing resource information necessary to execute the task associated with the source code, and transmitting, by the service platform, the calculated computing resource information to the manager node, and the allocating, by the manager node, the task associated with the source code to the one or more worker nodes, and receiving the information on the task result of the task from the one or more worker nodes may include allocating, by the manager node, the task to one or more worker nodes that satisfy the computing resource information, and receiving the information on the task result of the task from the one or more worker nodes.

According to an embodiment, the computing resource information may include information on at least one of a processor specification required to execute the task, support or non-support for graphics processing, and a storage capacity.

According to an embodiment, the allocating, by the manager node, the task to one or more worker nodes that satisfy the computing resource information, and receiving the information on the task result of the task from the one or more worker nodes may include determining, by the manager node, a plurality of worker nodes that satisfy the computing resource information, allocating, by the manager node, the task to one or more worker nodes of the plurality of worker nodes based on at least one of a delay in communication, a cost for performing the task, and reliability of each of the plurality of worker nodes, and receiving, by the manager node, the information on the task result of the task from the one or more worker nodes.

According to an embodiment, the allocating, by the manager node, the task to one or more worker nodes that satisfy the computing resource information, and receiving the information on the task result of the task from the one or more worker nodes may include performing, by the one or more worker nodes, the assigned task in a runtime execution environment based on a container, and providing the information on the task result of the task to the manager node.

According to an embodiment, the method may further include updating, by the manager node, the reliability of the one or more worker nodes based on the information on the task result.

According to an embodiment, the method may further include depositing, by the manager node, a reward for the task received from the user client, and recording, by the blockchain, information on the deposited reward.

According to an embodiment, the method may further include providing, by the manager node, at least a portion of the deposited reward to the one or more worker nodes based on the information on the task result, and recording, by the blockchain, information on the at least a portion of the reward provided to the one or more worker nodes.

According to an embodiment, the transmitting, by the service platform, the information on the task result to the user client so that the user client outputs the user interface to execute the task result may include transmitting, by the service platform, information on an Application Programming Interface (API) to execute the task result to the user client so that a user interface associated with the API is output.

According to an embodiment, there is provided a non-transitory computer-readable recording medium storing instructions for executing the method for providing a one-click distribution service on a computer.

A one-click distribution system according to an embodiment may include a service platform, a manager node, and one or more worker nodes, in which the service platform may analyze a source code included in a code repository selected by a user client, and transmit information on the source code to the manager node, the manager node may allocate a task associated with the source code to the one or more worker nodes, and receive information on a task result of the task from the one or more worker nodes, and the service platform may receive the information on the task result from the manager node, and transmit the information on the task result to the user client so that the user client outputs a user interface to execute the task result.

In various embodiments of the present disclosure, the user can reduce operation cost for a machine learning task by up to 2 times compared to the related centralized cloud, and can also reduce the time of building the environment for source code development related to the machine learning tasks by about 50% or more. In addition, the user can avoid a lock-in of the machine learning task to a specific centralized cloud.

In various embodiments, the user can execute and/or distribute the source code stored in the code repository by simply inputting the link address of the code repository in the one-click distribution system, and execute and/or use the task result.

In various embodiments, a manager node of a hybrid computing system may consider various factors to determine an optimal worker node for processing a task request from a client or service platform. The reliability of the worker node determined according to various factors eventually becomes an important factor when a client selects a node to process its request, and worker nodes with low reliability are not normally assigned with tasks. Accordingly, each resource provider node or worker nodes in the system can be induced to perform tasks in such a way as to improve its reliability.

The effects of the present disclosure are not limited to the effects described above, and other effects not described will be able to be clearly understood by those of ordinary skill in the art (hereinafter, referred to as “ordinary technician”) from the description of the claims.

### BRIEF DESCRIPTION OF THE DRAWINGS

Embodiments of the present disclosure will be described with reference to the accompanying drawings described below, in which like reference numerals denote like elements, but are not limited thereto:

FIG. 1 is a diagram illustrating an example in which a service platform, a manager node, a worker node, a blockchain, and a centralized/commercial cloud provide a one-click distribution service according to an embodiment;

FIG. 2 is a schematic diagram illustrating a configuration in which a one-click distribution system is communicatively connected to a plurality of user clients in order to provide a one-click distribution service in linkage with a code repository according to an embodiment;

FIG. 3 is a block diagram illustrating an internal configuration of the service platform according to an embodiment;

FIG. 4 is a diagram illustrating an exemplary configuration in which the manager node allocates a task and the worker node performs the task according to an embodiment;

FIG. 5 is a flowchart illustrating a method for providing a one-click distribution service according to an embodiment;

FIG. 6 is a diagram illustrating an example of a user interface providing a one-click execution button according to an embodiment;

FIG. 7 is a diagram illustrating an example of a user interface that provides an API list according to an embodiment; and

FIG. 8 is a flowchart illustrating a method for providing a one-click distribution service according to an embodiment.

### DETAILED DESCRIPTION OF THE INVENTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding components may be omitted. However, even if descriptions of components are omitted, it is not intended that such components are not included in any embodiment.

The terms used in the present disclosure will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the embodiments. Therefore, the terms used in the present disclosure should be defined based on the meaning of the terms and the overall content of the present disclosure rather than a simple name of each of the terms.

In the present disclosure, the singular forms “a,” “an,” and “the” are intended to include the plural forms as well, unless the context clearly indicates the singular forms. Further, the plural forms are intended to include the singular forms as well, unless the context clearly indicates the plural forms.

In the present disclosure, when a portion is stated as “comprising (including)” a component, unless specified to the contrary, it intends to mean that the portion may additionally comprise (or include or have) another component, rather than excluding the same.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the present embodiments are merely provided to make the present disclosure complete, and to fully disclose the scope of the invention to those skilled in the art to which the present disclosure pertains.

In the present disclosure, the “system” may refer to at least one of a server device and a cloud device, but not limited thereto. For example, the system may include one or more server devices. As another example, the system may include one or more cloud devices. As another example, the system may be configured together with both a server device and a cloud device and operated.

In the present disclosure, a “code repository” may include a repository configured to store, update, share, or manage one or more source codes and/or files developed or generated by various developers. Alternatively, the “code repository” may refer to one or more source codes and/or files themselves contained in the code repository.

In the present disclosure, a “user client” may refer to a computing device and/or a system such as a user terminal which communicates with a one-click distribution system. Alternatively, the “user client” may refer to the user himself who uses a computing device and/or a system such as a user terminal or the like communicating with the one-click distribution system.

In the present disclosure, a “task” may include the task of executing and distributing a source code included in a code repository. For example, when the code repository contains a source code for an artificial intelligence or machine learning model, the “task” may include generating and updating a machine learning model, and/or distributing the generated machine learning model. In the present disclosure, a “task result” and/or “information on task result” may include whether the requested task has succeeded or failed, and a result of executing the source code. For example, the task result may include whether the task of distributing and/or executing the source code has succeeded or failed, and the machine learning model itself that is trained and/or distributed.

In the present disclosure, “information on source code included in code repository” may include the source code itself included in the code repository, information on generation/modification of the source code, and/or information for executing the source code. For example, the information on source code included in code repository may include computing resource information required to execute a task associated with the source code.

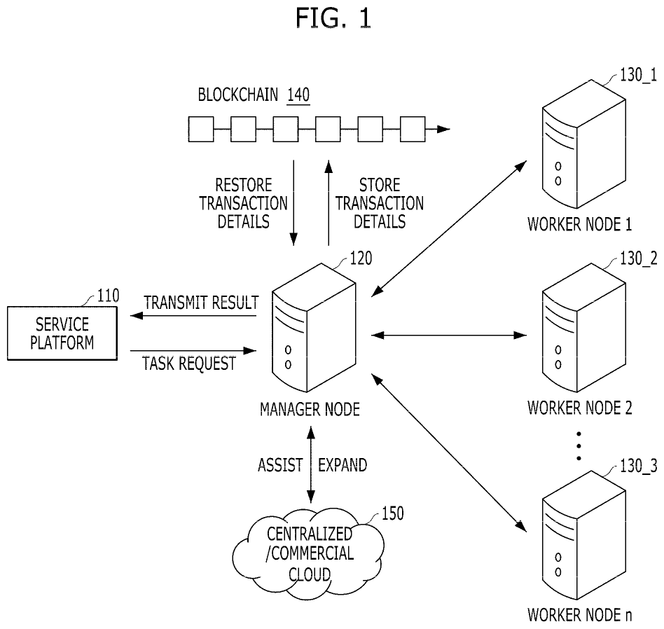

FIG. 1 is a diagram illustrating an example in which a service platform 110, a manager node 120, worker nodes 130_1, 130_2, and 130_3, a blockchain 140, and a centralized/commercial cloud 150 provide a one-click distribution service according to an embodiment. In order to provide a one-click distribution service, a one-click distribution system may include the service platform 110, a hybrid computing system, and the blockchain 140. The service platform 110 may include a Machine Learning as a Service (MLaaS) platform that extracts and refines specifications necessary for distributing the source code included in the code repository based on the link address (e.g., a URL address received from a user or a client, and the like) of the code repository, and transmits it to the hybrid computing system. In response to a task request for the code repository received from the service platform 110, the hybrid computing system may execute and/or distribute the source code included in the code repository. In an embodiment, the hybrid computing system may include the manager node 120, a plurality of worker nodes 130, and the centralized/commercial cloud 150. In this example, the worker node 130 may refer to a resource (or asset) provider node that provides computing resources including a processor, a storage, and the like necessary for the execution of the source code. The manager node 120 stores and manages details of transaction between the user client (not illustrated) and the worker node 130 through the blockchain 140 to provide an escrow service for ensuring a safe transaction between the user client and the worker node 130.

The service platform 110 may transmit the information on the source code included in the code repository selected by the user client (e.g., the code repository associated with the link address received from the user client) to the manager node 120. In an embodiment, the service platform 110 may analyze the source code included in the code repository selected by the user client to calculate computing resource information required to execute the task associated with the source code. In this example, the computing resource information may include a processor specification required to execute a task associated with the source code, support or non-support for graphics processing, storage capacity, and the like. Then, the service platform 110 may transmit the task request for the source code and the calculated computing resource information to the manager node 120. For example, the service platform 110 may refine the calculated computing resource information into a form suitable for the specification for the task request, and provide it to the manager node 120.

The manager node 120 may allocate a task for the source code to one or more worker nodes among the plurality of worker nodes 130_1, 130_2, and 130_3 according to the task request of the service platform 110. In an embodiment, the manager node 120 may assign tasks to one or more worker nodes that satisfy the computing resource information received from the service platform 110. For example, the manager node 120 may determine a plurality of worker nodes that satisfy the computing resource information received from the service platform 110, and assign tasks to one or more worker nodes among the plurality of worker nodes based on a delay in communication, cost for performing task and reliability, and the like of each of the plurality of worker nodes. In another embodiment, the manager node 120 may calculate the computing resource information required to execute the task associated with the source code based on the information on the source code received from the service platform 110, and allocate the task to one or more worker nodes that satisfy the calculated computing resource information. In another embodiment, the manager node 120 may redirect the task request to the centralized/commercial cloud 150. For example, when there is no extra worker node present in the hybrid computing system, the manager node 120 may transfer the requested task to the centralized/commercial cloud 150 for processing thereof. In another embodiment, the manager node 120 may allocate the task for the source code to one or more worker nodes among the plurality of worker nodes 130_1, 130_2, and 130_3 as selected by the user client. Meanwhile, in an embodiment, when the worker nodes 130_1, 130_2, and 130_3 cannot perform the task assigned from the manager node 120, the manager node 120 may reallocate the task to another worker node.

The worker nodes 130_1, 130_2, and 130_3 may execute the tasks assigned from the manager node 120. For example, the worker nodes 130_1, 130_2, and 130_3 may execute the assigned tasks in a runtime execution environment based on a container. Then, the worker nodes 130_1, 130_2, and 130_3 may transmit information on task result of the performed task to the manager node 120. The manager node 120 may provide the received information on task result to the service platform 110, and the service platform 110 may provide the information on task result to the user client. For example, the manager node 120 may provide part of the received information on task result to the service platform 110, and the service platform 110 may provide part of the received information on task result to the user client. In an embodiment, the service platform 110 may transmit the information on task result provided from the manager node 120 to the user client, and output a user interface through which the user client can check or execute the task result.

In an embodiment, the manager node 120 may determine the reliability of the worker nodes 130_1, 130_2, and 130_3 based on the activity details of the worker nodes 130_1, 130_2, and 130_3, or update the reliability of the worker nodes 130_1, 130_2, and 130_3 based on the information on task result. For example, the manager node 120 may update to increase the reliability level of the worker node that successfully processed the requested task, while updating to decrease the reliability level of the worker node that had a problem in performing the task. In an embodiment, the worker nodes 130_1, 130_2, and 130_3 may periodically transmit a message to inform normal operation thereof to the manager node 120. In this case, the manager node 120 may update to decrease the reliability level of the worker nodes 130_1, 130_2, and 130_3 that do not transmit the messages for more than a certain period of time. The reliability of the worker nodes 130_1, 130_2, and 130_3 may be considered when the user client and the manager node 120 select a worker node to assign a task to, and the worker nodes 130_1, 130_2, and 130_3 with low reliability may not be assigned with a task. Accordingly, the worker nodes 130_1, 130_2, and 130_3 may have to process the assigned task well enough or periodically transmit the message to inform normal operation thereof in order to improve or maintain their reliability.

In an embodiment, the blockchain 140 may process all transactions that occur in the interaction between the user client and the worker nodes 130_1, 130_2, and 130_3, and record the details of the transactions. In this example, the transactions between the user client and the worker nodes 130_1, 130_2, and 130_3 may include a primary transaction between the user client and the manager node 120 of the hybrid computing system, and a secondary transaction between the manager node 120 and the worker nodes 130_1, 130_2, and 130_3. In the primary transaction, the user client temporarily deposits the reward for the requested task to the manager node 120, and the manager node 120 may allocate the task to the worker nodes 130_1, 130_2, and 130_3 after confirming the deposit. In the secondary transaction, the manager node 120 may inspect the task result based on the information on task result received from the worker nodes 130_1, 130_2, and 130_3, and process the deposited reward according to the inspection result. For example, when the task result corresponds to or exceed a preset criterion, the manager node 120 may deliver the reward deposited in the primary transaction to the worker nodes 130_1, 130_2, and 130_3. On the other hand, when the task result falls short of the preset criterion, the manager node 120 may refund the deposited fee to the user client. Alternatively, when the task result partially falls short of the criterion, the manager node 120 may provide a portion of the deposited reward to the worker nodes 130_1, 130_2, and 130_3, and refund the remaining portion to the user client. The blockchain 140 may record and store the details of these primary and secondary transactions and transparently manage them, and the recorded and stored transaction details may be restored by the manager node 120.

While FIG. 1 illustrates a configuration in which the service platform 110, the manager node 120, the worker nodes 130_1, 130_2, and 130_3, the blockchain 140, and the centralized/commercial cloud 150 are connected to each other in order to provide the one-click distribution service, the present disclosure is not limited thereto. For example, certain components may be omitted or other components may be further added. In addition, while FIG. 1 illustrates that three worker nodes 130_1, 130_2, and 130_3 communicate with the manager node 120, the present disclosure is not limited thereto, and it may be configured such that a different number of worker nodes 130_1, 130_2, and 130_3 communicate with the manager node 120.

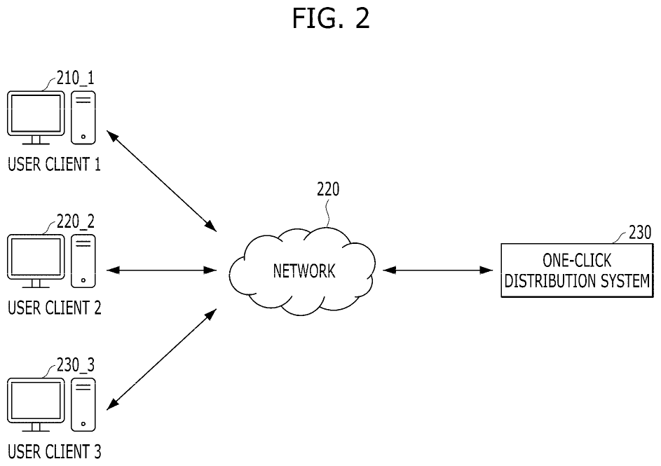

FIG. 2 is a schematic diagram illustrating a configuration in which a one-click distribution system 230 is connected for communication with a plurality of user clients 210_1, 210_2, and 210_3 to provide a one-click distribution service in linkage with a code repository according to an embodiment. The one-click distribution system 230 may include a system(s) capable of providing a one-click distribution service. In an embodiment, the one-click distribution system 230 may include one or more server devices and/or databases, or one or more distributed computing devices and/or distributed databases based on cloud computing services, which can store, provide and execute computer-executable programs (e.g., downloadable applications) and data associated with the one-click distribution service. For example, the one-click distribution system 230 may include separate systems (e.g., servers, computing devices, and the like) for providing the one-click distribution service.

The one-click distribution service provided by the one-click distribution system 230 may be provided to the user through an application and the like for the one-click distribution service installed in each of the plurality of user clients 210_1, 210_2, and 210_3. Alternatively, the user clients 210_1, 210_2, and 210_3 may process tasks such as source code analysis, computing resource information calculation, and the like, using a one-click distribution service program/algorithm stored therein. In this case, the user clients 210_1, 210_2, and 210_3 may directly process tasks such as source code analysis, computing resource information calculation, and the like without communicating with the one-click distribution system 230.

The plurality of user clients 210_1, 210_2, and 210_3 may communicate with the one-click distribution system 230 through a network 220. The network 220 may be configured to enable communication between the plurality of user clients 210_1, 210_2, and 210_3 and the one-click distribution system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, and so on) that may be included in the network 220 as well as short-range wireless communication between the user clients 210_1, 210_2 and 210_3.

FIG. 2 illustrates PC terminals as an example of the user clients 210_1, 210_2, and 210_3, but the present disclosure is not limited thereto, and the user clients 210_1, 210_2, and 210_3 may be any computing device capable of wired and/or wireless communication. For example, the user client may include a smart phone, a mobile phone, a computer, a notebook computer, a Personal Digital Assistant (PDA), a Portable Multimedia Player (PMP), a tablet PC, and the like. In addition, FIG. 2 illustrates that the three user clients 210_1, 210_2, and 210_3 are in communication with the one-click distribution system 230 through the network 220, but embodiments are not limited thereto, and a different number of user clients may be configured to be in communication with the one-click distribution system 230 through the network 220.

In an embodiment, the one-click distribution system 230 may receive data (e.g., the link address of the code repository, the source code included in the code repository, and the like) from the user clients 210_1, 210_2, and 210_3 through an application and the like for a one-click distribution service running on the user clients 210_1, 210_2, and 210_3. In addition, the one-click distribution system 230 may transmit the information on task result to the user clients 210_1, 210_2, and 210_3, so that the user clients 210_1, 210_2, and 210_3 output a user interface to execute the task result. When the user clients 210_1, 210_2, and 210_3 use the one-click distribution system 230 to operate a machine learning task, it is possible to reduce operation cost and reduce the time to build the environment for machine learning development.

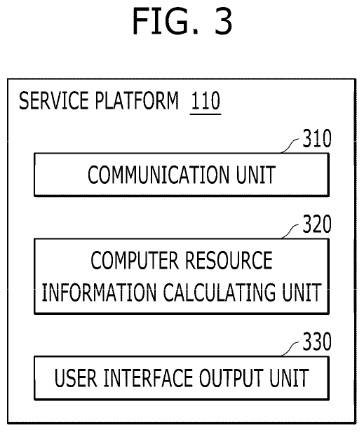

FIG. 3 is a block diagram illustrating an internal configuration of the service platform 110 according to an embodiment. The service platform 110 of the one-click distribution system (230 in FIG. 2) may include a communication unit 310, a computer resource information calculation unit 320, and a user interface output unit 330. The communication unit 310 may be configured to allow the service platform 110 to communicate with the user client and/or the manager node. In an embodiment, the communication unit 310 may receive information on the code repository (e.g., a code repository URL address, a file included in the code repository, information on source code, and the like) from the user client.

The computer resource information calculation unit 320 may analyze the source code included in the code repository based on the information on the code repository received through the communication unit 310, and calculate the computing resource information required to execute a task associated with the source code. In this example, the computing resource information may include information on at least one of a processor specification required to execute a task, support or non-support for graphics processing, and storage capacity. In an embodiment, the computer resource information calculating unit 320 may analyze the source code based on the file used in the execution of the source code, and extract a specification necessary for executing and/or distributing the source code.

For example, in the case of a code repository using Docker, the computer resource information calculating unit 320 may analyze a configuration file having a file name of “Dockerfile” or “docker-compose.yml”, to extract an operating system (OS), a framework, an execution command, and port numbers necessary for the execution of the source code of the code repository. Alternatively, when a project using “Node.js” is included in the code repository, the computer resource information calculation unit 320 may extract the OS, framework, execution command, and port numbers necessary for the execution of the source code of the code repository based on whether or not there is the “package.json” file and the file analysis information. Alternatively, when a project using “Python” is included in the code repository, the computer resource information calculation unit 320 may extract the OS, framework, execution command, and port numbers necessary for the execution of the source code of the code repository through a “requirements.txt” file.

The service platform 110 may refine the computing resource information calculated by the computer resource information calculation unit 320 into a form suitable for a specification for the task request, and provide it to the hybrid computing system through the communication unit 310. Then, the communication unit 310 may receive the information on task result from the manager node. The user interface output unit 330 may provide the received information on task result (e.g., whether the source code execution and/or distribution has succeeded or not, and the like) to the user client through the communication unit 310, and output a user interface through which the user client can execute the job result. For example, the user interface output unit 330 may request the user client to output a user interface including a button to execute the task result.

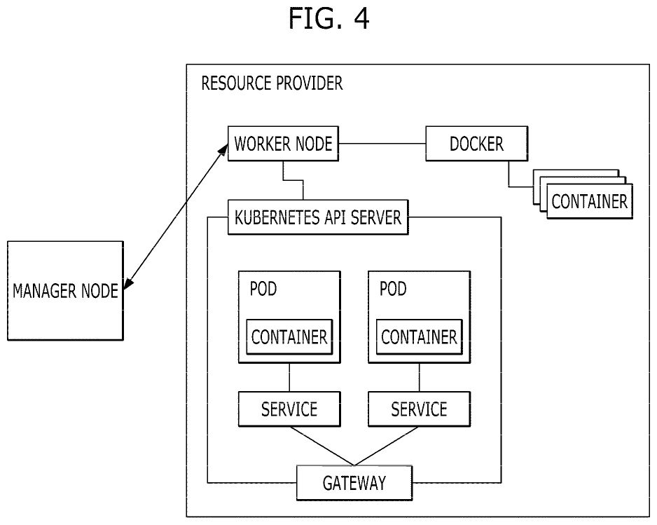

FIG. 4 is a diagram illustrating an exemplary configuration in which a manager node 410 allocates a task and a worker node 420 performs the task according to an embodiment. The manager node 410 may assign the task to one or more worker nodes 420 (or resource providers) that satisfy the computing resource information (e.g., CPU specifications, support for GPU and its specifications, memory and disk free spaces, and the like) received from the service platform. Alternatively or additionally, the manager node 410 may assign the tasks to the one or more worker nodes 420 of the plurality of worker nodes based on at least one of delay in communication, cost for performing task, and reliability of each of the plurality of worker nodes.

The one or more worker nodes 420 may perform the assigned tasks. In an embodiment, the worker nodes 420 may perform the assigned task in a runtime execution environment based on a container. That is, the worker node 420 has an off-chain secure runtime environment, and accordingly start and execute the tasks assigned from the manager node 410. For example, the worker node 420 may manage a cluster based on Kubernetes (Kubernetes or K8s) to execute the assigned task. Alternatively, the worker node 420 may manage a cluster based on a simple Docker for the purpose of weight reduction. The worker node 420 may use the kubect1 command when the assigned task is executable based on Kubernetes. Alternatively, the worker node 420 may execute a Docker command when the assigned task is executable based on Docker. As illustrated, the worker node 420 may communicate with the Kubernetes Application Programming Interface (API) server when the task assigned from the manager node 410 is based on Kubernetes, and communicate with the Docker daemon when it is based on Docker. In this example, the Kubernetes API server may include one or more pods, and each pod may include one or more containers.

The worker node 420 may provide the information on task result of the task it performed to the manager node 410. In an embodiment, the manager node 410 may update the reliability of the worker node 420 that performed the task based on the information on task result. In an embodiment, the manager node 410 may provide at least a portion of the deposited reward to the one or more worker nodes 420 based on the information on task result. In this case, the manager node 410 may record information on the at least a portion of the reward provided to the worker node 420 in the blockchain.

In an embodiment, the manager node 410 may receive a task request from a service platform (not illustrated) through an API as illustrated in Table 1 below. In addition, the manager node 410 may receive the task result from the worker node 420 through the API as illustrated in Table 2 below and process the same.

TABLE 1

| API Name | Description of Fuction |
|---|---|
| createResource | Resource Creation Request Parameters |
| | hardwareSpec: object |
| | containerImage: string |
| | (opt) clusterName: string |
| | (opt) clusterAddress: string |
| | Response |
| | resourceId: string |
| | endpoint: string |
| deleteResource | Created Resource Delete Request |
| | Parameters |
| | resourceId: string |
| | Response |
| | resultCode |
| getResourceStatus | Resource Status Info. Request Parameters |
| | resourceId: string |
| | Response |
| | status |
| setResourceConfig | Resource Environment Variable Update |
| | Request Parameters |
| | {[key]: value} |
| | Response |
| | resultCode |

TABLE 2

| API Name | Description of Fuction |
|---|---|
| register | Registration of Worker Node to Hybrid |
| | Computing System |
| | Parameters |
| | clusterOptions: object |
| | Response |
| | resultCode |
| listenJob | Registration of Definition of Callback |
| | Function to be Executed for Each |
| | Task Type |
| | Parameters |
| | {[requestType]: callbackFunction} |
| response | Processed Task Result Registration |
| | Parameters |
| | requestId: string |
| | responsePayload: object |
| updateClusterInfo | Managed Cluster Info. Update |
| | Parameters |
| | clusterOptions: object |

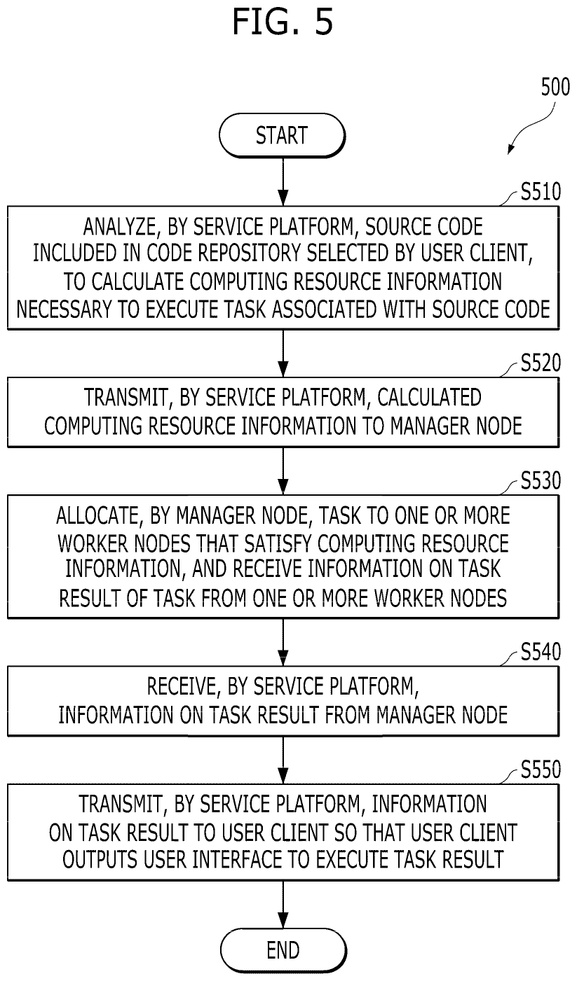

FIG. 5 is a flowchart illustrating a method 500 for providing a one-click distribution service according to an embodiment. In an embodiment, the method 500 for providing a one-click distribution service may be performed by a one-click distribution system (e.g., by at least one configuration of the one-click distribution system). As illustrated, the method 500 for providing a one-click distribution service may be initiated by the service platform analyzing the source code included in the code repository selected by the user client, calculating computing resource information necessary to execute a task associated with the source code (S510), and transmitting the calculated computing resource information to the manager node (S520). In this example, the computing resource information may include information on at least one of a processor specification required to execute a task, support or non-support for graphics processing, and storage capacity.

Then, the manager node may allocate a task to one or more worker nodes that satisfy the computing resource information, and receive the information on task result of the task from the one or more worker nodes (S530). In an embodiment, the manager node may determine a plurality of worker nodes that satisfy the computing resource information, allocate the task to one or more worker nodes of the plurality of worker nodes based on at least one of delay in communication, cost for performing task, and reliability of each of the plurality of worker nodes, and receive the information on task result of the task from the one or more worker nodes. In an embodiment, the one or more worker nodes may perform the assigned task in a runtime execution environment based on a container, and provide the information on task result of the task to the manager node.

Then, the service platform may receive the information on task result from the manager node (S540), and transmits the information on task result to the user client so that the user client outputs a user interface to execute the task result (S550). In an embodiment, the one or more worker nodes may perform the assigned task in a runtime execution environment based on a container, and provide the information on task result of the task to the manager node.

In an embodiment, the manager node may update the reliability of the one or more worker nodes based on the information on task result. In an embodiment, the manager node may deposit a reward for the task received from the user client and record by the blockchain the information on the deposited reward. In an embodiment, the manager node may provide at least a portion of the deposited reward based on the information on task result to one or more worker nodes, and record by the blockchain the information on at least the portion of the reward provided to the one or more worker nodes.

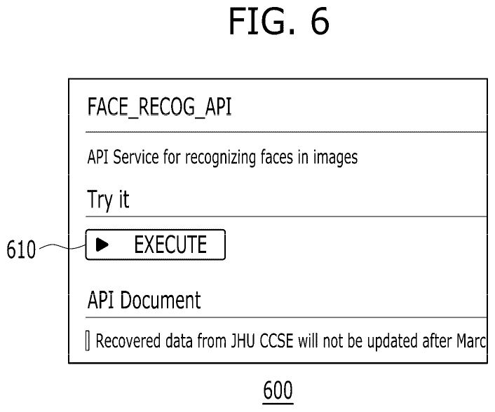

FIG. 6 is a diagram illustrating an example of a user interface 600 providing a one-click execution button 610 according to an embodiment. The service platform may transmit the information on task result received from the manager node (that is, from the hybrid computing system) to the user client so that the user client outputs the user interface 600 to execute the task result. In an embodiment, when the task result is received from the hybrid computing system, the service platform may request the user client to generate the button 610 for the task result. In this example, the button 610 for the task result may be a button for executing the result distributed in the code repository in the form of Pull Request (request to reflect a new task). In response to the request, the user client may output the user interface 600 including the button 610 for the task result. In response to a user input to the output execution button 610, the user client may execute the source code distributed directly from the code repository.

For example, when the source code for an artificial intelligence-based facial recognition model is included in the code repository or source code selected and/or provided by the user client (e.g., in the code repository or source code associated with a link address selected and/or provided by the user client), the service platform may receive information on the trained and distributed face recognition model from the hybrid computing system. The service platform may transmit the received information to the user client, so as to output the user interface 600 to execute, by the user, the trained and distributed face recognition model. As illustrated, the user interface 600 to execute the task result may include information such as a name of API “FACE_RECOG_API” that can execute the task result, a description of the API “API Service for recognizing faces in images”, an API document, and the like, and/or the button 610 for executing the task result.

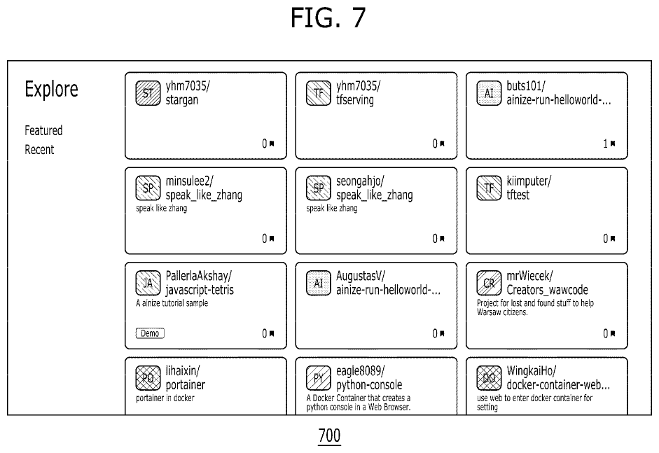

FIG. 7 is a diagram illustrating an example of a user interface 700 that provides an API list according to an embodiment. In an embodiment, the service platform may analyze the file and source code included in the code repository received from the user client, and/or the information on task result received from the manager node, and extract one or more application programming interfaces (APIs) generated by the distribution of the code repository. In this example, the extracted one or more APIs may include an API to execute a task result for the code repository. For example, the service platform may analyze the files and/or codes in which information on API is defined, such as a “swagger.yaml” file and the like included in the code repository, to extract a list of available APIs.

The service platform may transmit the information on one or more APIs that can execute the task result to the user client to output the user interface 700 associated with the API. In an embodiment, the service platform may transmit the extracted list of APIs to the user client so that the user interface 700 including the list of APIs is output. For example, the user client may output the user interface 700 including a plurality of APIs classified by a repository unit, a project unit, a category unit, and the like.

The user may search, select, execute, and/or use one or more APIs through the user interface 700 output to the user client. For example, the user interface 700 may include a search bar for searching at least one API among a plurality of APIs, and the user may input a search term in the search bar to search for one or more APIs associated with the input search term. Alternatively or additionally, the user may make a user input for at least one API among the plurality of APIs displayed through the user interface 700 to execute and/or use that API.

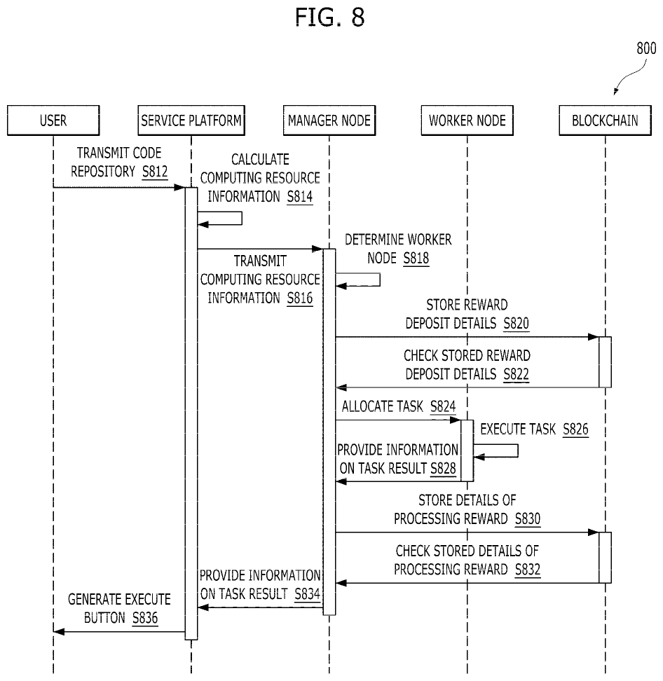

FIG. 8 is a flowchart illustrating a method 800 for providing a one-click distribution service according to an embodiment. The user (or user client) may provide the information on the code repository to the service platform (S812). In this example, the information on the code repository may include a link address (e.g., URL address) of the code repository, a file and/or source code included in the code repository, or a link address thereof. The service platform may analyze the file and/or source code included in the code repository, calculate the computing resource information necessary to execute the task associated with the source code (S814), and transmit the calculated computing resource information to the manager node (S816). The manager node may determine one or more worker nodes that satisfy the received computing resource information (S818). The user may deposit the reward for the requested task in the manager node. The manager node may store and record the information on the deposited reward, that is, may store and record details of reward deposit in the blockchain (S820), and check the stored and recorded details of reward deposit from the blockchain (S822). After completion of the reward deposit, the manager node may assign the task to one or more worker nodes determined at S818 (S824). The worker node may perform the assigned task (S826), and provide the information on task result to the manager node (S828).

The manager node may process the deposited reward based on the information on task result received from the worker node. For example, the manager node may verify the task result based on the information on task result, and when the task result corresponds to or exceed a preset criterion, the manager node may deliver the deposited reward to the worker node. On the other hand, when the task result falls short of the preset criterion, the manager node may refund the deposited reward to the user (or to the user client). Alternatively, when the task result partially falls short of the preset criterion, the manager node may provide a portion of the deposited reward to the worker node, and refund the remaining portion to the user (or to the user client). The manager node may store and record the details of processing the reward in the blockchain (S830), and check the stored and recorded details of processing the reward from the blockchain (S832). After the reward is processed, the manager node may provide the information on task result received from the worker node to the service platform (S834). The service platform may cause to generate an execution button in the user client based on the received information on task result (S836).

The method for providing a one-click distribution service described above may be provided as a computer program stored in a computer-readable recording medium for execution on a computer. The medium may continuously store a program executable by a computer or temporarily store a program for execution or download. In addition, the medium may be a variety of recording means or storage means in a form in which a single piece of hardware or several pieces of hardware are combined, but is not limited to a medium directly connected to any computer system, and may be present on a network in a distributed manner. An example of the medium includes a medium that is configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of this disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

The above description of the present disclosure is provided to enable those skilled in the art to make or use the present disclosure. Various modifications of the present disclosure will be readily apparent to those skilled in the art, and the general principles defined herein may be applied to various modifications without departing from the spirit or scope of the present disclosure. Thus, the present disclosure is not intended to be limited to the examples described herein but is intended to be accorded the broadest scope consistent with the principles and novel features disclosed herein.

Although example implementations may refer to utilizing aspects of the presently disclosed subject matter in the context of one or more standalone computer systems, the subject matter is not so limited, and they may be implemented in conjunction with any computing environment, such as a network or distributed computing environment. Furthermore, aspects of the presently disclosed subject matter may be implemented in or across a plurality of processing chips or devices, and storage may be similarly influenced across a plurality of devices. Such devices may include PCs, network servers, and handheld devices.

Although the present disclosure has been described in connection with some embodiments herein, it should be understood that various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for providing a one-click distribution service in linkage with a code repository, comprising:
transmitting, by a service platform, information on a source code included in a code repository selected by a user client to a manager node;
allocating, by the manager node, a task associated with the source code to one or more worker nodes, and receiving information on a task result of the task from the one or more worker nodes;
receiving, by the service platform, the information on the task result from the manager node; and
transmitting, by the service platform, the information on the task result to the user client so that the user client outputs a user interface to execute the task result.

2. The method according to claim 1, wherein
the transmitting, by the service platform, the information on the source code included in the code repository selected by the user client to the manager includes:
analyzing, by the service platform, the source code included in the code repository selected by the user client, to calculate computing resource information necessary to execute the task associated with the source code; and
transmitting, by the service platform, the calculated computing resource information to the manager node, and
the allocating, by the manager node, the task associated with the source code to the one or more worker nodes, and receiving the information on the task result of the task from the one or more worker nodes includes:
allocating, by the manager node, the task to one or more worker nodes that satisfy the computing resource information, and receiving the information on the task result of the task from the one or more worker nodes.

3. The method according to claim 2, wherein the computing resource information includes information on at least one of a processor specification required to execute the task, support or non-support for graphics processing, and a storage capacity.

4. The method according to claim 2, wherein the allocating, by the manager node, the task to one or more worker nodes that satisfy the computing resource information, and receiving the information on the task result of the task from the one or more worker nodes includes:
determining, by the manager node, a plurality of worker nodes that satisfy the computing resource information;
allocating, by the manager node, the task to one or more worker nodes of the plurality of worker nodes based on at least one of a delay in communication, a cost for performing the task, and reliability of each of the plurality of worker nodes; and
receiving, by the manager node, the information on the task result of the task from the one or more worker nodes.

5. The method according to claim 1, wherein the allocating, by the manager node, the task associated with the source code to the one or more worker nodes, and receiving the information on the task result of the task from the one or more worker nodes includes:
performing, by the one or more worker nodes, the assigned task in a runtime execution environment based on a container, and providing the information on the task result of the task to the manager node.

6. The method according to claim 1, further comprising updating, by the manager node, the reliability of the one or more worker nodes based on the information on the task result.

7. The method according to claim 1, further comprising:
depositing, by the manager node, a reward for the task received from the user client; and
recording, by a blockchain, information on the deposited reward.

8. The method according to claim 7, further comprising:
providing, by the manager node, at least a portion of the deposited reward to the one or more worker nodes based on the information on the task result; and
recording, by the blockchain, information on the at least a portion of the reward provided to the one or more worker nodes.

9. The method according to claim 1, wherein the transmitting, by the service platform, the information on the task result to the user client so that the user client outputs the user interface to execute the task result includes:
transmitting, by the service platform, information on an Application Programming Interface (API) to execute the task result to the user client so that a user interface associated with the API is output.

10. A non-transitory computer-readable recording medium storing instructions for executing the method according to claim 1 on a computer.

11. A one-click distribution system comprising a service platform, a manager node, and one or more worker nodes, wherein
the service platform transmits information on a source code included in a code repository selected by a user client to the manager node,
the manager node allocates a task associated with the source code to the one or more worker nodes, and receives information on a task result of the task from the one or more worker nodes, and
the service platform receives the information on the task result from the manager node, and transmits the information on the task result to the user client so that the user client outputs a user interface to execute the task result.
